(19) United States
(12) Patent Application Publication
(10) Pub. No.: US 2009/0100093 A1
(43) Pub. Date: Apr. 16, 2009

(54) APPARATUS, SYSTEM, METHOD AND COMPUTER PROGRAM PRODUCT FOR PREVIEWING MEDIA FILES

(75) Inventor: Mikko Johannes Makipaa, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/872,913

(22) Filed: Oct. 16, 2007

(51) Int. Cl. G06F 17/30

(52) U.S. Cl. 707/104.1; 707/E17.009

(57) ABSTRACT

An apparatus, system, method and computer program product are provided for generating a preview of one or more media files and/or collections of media files stored on a user's device, wherein the preview may be specifically designed to enable the user to quickly and easily recognize the media file and/or collection of media files. In particular, when a user requests to hear and/or view a preview of a collection of media files stored on his or her device, the user's device may first select which of the media files of the selected collection are most likely to be recognized by the user. The device may then determine which portion of those media files selected the user is most likely to quickly and easily recognize. The device may then combine the recognizable or representative portions of each of the recognizable or representative media files into a preview for outputting to the user.

### FIELD

Embodiments of the invention relate, generally, to techniques for facilitating the browsing of media files stored on a user's device and/or media provider server and, in particular, to a technique for enabling a user to preview a media file and/or a collection of media files.

### BACKGROUND

People are increasingly storing and accessing more and more media files, such as audio, video, and/or multimedia files, on their electronic devices (e.g., cellular telephones, personal digital assistants (PDAs), personal computers (PCs), laptops, etc.). For example, many individuals store entire music collections in the form of MP3 files on their cell phones or other mobile devices. These individuals may then use some form of a music player implemented on their device to select and playback the songs from their collection. Similarly, it is becoming increasingly popular to download and replay entire television programs and movies using one's electronic device.

With the increase in the number of media files (e.g., songs, television programs, movies, etc.) stored on an individual's device, the harder it becomes for the individual to remember what media files he or she owns and, in some instances, which of the media files owned that he or she likes and dislikes. As a result, individuals having large collections of media files may have a difficult time selecting which media file to play at a particular moment in time. For example, it would seem likely that an individual with a large collection may be unable to remember each song in his or her collection based solely on the artist's name and/or the title of the song, which, in many instances, is the only information provided to the individual. Similarly the individual may not be able to remember a movie or television program in his or her collection based on the title of the movie or television series alone.

In many instances, it may be helpful for the individual to be reminded of what a particular artist sounds like, what songs are included on a particular album he or she owns, what movies or television programs a user owns in which a particular actor played, and/or what songs, movies and/or television programs the user owns that might fall within a particular genre.

A need, therefore, exists for a way to provide an individual with this, and other, information regarding the media files he or she owns in a quick and easy manner that will be the most helpful to the individual.

### BRIEF SUMMARY

In general, embodiments of the present invention provide an improvement by, among other things, providing a way to generate and provide a user of an electronic device with a preview of one or more media files and/or collections of media files stored on the user's device and/or a media provider server, wherein the preview is specifically designed to provide the user with a comprehensive and representative look at the media files and/or collections. In one embodiment, this may enable the user to more quickly and easily recognize the media file and/or collection of media files he or she owns or is considering purchasing. In particular, according to one embodiment, when a user requests to hear and/or view a preview of a collection of media files stored on his or her device, the user's device may first select which of the media files of the selected collection are most representative of the collection and/or are most likely to be recognized by the user (i.e., one or more representative media files). The device may then determine which portion of those media files selected is most representative of the media file and/or is most likely to be quickly and easily recognized by the user (i.e., a representative portion of the representative media files). The device may then combine the recognizable or representative portions of each of the recognizable or representative media files into a preview for outputting to the user. In one embodiment, the information identifying the representative media files and representative portions thereof may be stored in association with the corresponding media files. Alternatively, this information may be determined dynamically, or on the fly, each time a user requests to receive a preview of the media file and/or collection of media files.

To illustrate, assume, for example that the user would like to preview an album saved in his or her device. In response to receiving a request to do so, the user's device may determine which of the songs on the album selected are most popular, either with the user him- or herself, or with the population as a whole (e.g., based on statistical information provided by a media provider server). The user's device may then locate, for example, the chorus of each of the most popular songs, and then combine the choruses together for the preview.

In accordance with one aspect, an apparatus is provided for generating a preview of a subset or collection of media files stored on the apparatus. In one exemplary embodiment, the apparatus may include a processor configured to: (1) obtain a plurality of media files; (2) identify a representative portion of respective media files obtained; (3) define one or more subsets of the plurality of media files; (4) identify one or more representative media files of respective subsets, wherein the identified media files are representative of the corresponding subset; (5) receive a request to preview at least one of the subsets of the plurality of media files; and (6) generate and output, in response to the request received, a combination of the representative portions of the representative media files of the at least one subset.

In one embodiment, the plurality of media files may include one or more audio files, one or more video files, or a combination thereof. According to this embodiment, in order to identify a representative portion of respective media files, the processor may be configured to identify a start time and at least one of an end time or length of a chorus associated with respective audio files and/or a climax associated with respective video files.

In one embodiment, in order to define one or more subsets of the plurality of media files, the processor may be further configured to define at least one parameter associated with respective media files, wherein respective subsets include one or more media files having a substantially similar definition associated with the parameter. This parameter may include, for example, an album title, recording artist, genre, year, country, television series title, actor, producer or director, to name a few. In another embodiment, in order to define one or more subsets of the plurality of media files, the processor may be further configured to receive, as an input from a user of the apparatus, a play list including one or more media files of the plurality of media files.

In one embodiment, in order to identify one or more representative media files of respective subsets, the processor may be further configured to monitor a number of times a user of the apparatus outputs respective media files to determine which of the one or more media files of the subset are more frequently output.

In accordance with another aspect, a system is provided for generating a preview of a subset or collection of media files stored on an apparatus. In one embodiment, the system may include a network entity and an electronic device in communication with the network entity for the purpose of downloading a plurality of media items. The electronic device of this embodiment may be configured to: (1) identify a representative portion of respective media files downloaded; (2) define one or more subsets of the plurality of media files; (3) identify one or more representative media files of respective subsets, wherein the identified media files are representative of the corresponding subset; (4) receive a request to preview at least one of the subsets of the plurality of media files; and (5) generate and output, in response to the request received, a combination of the representative portions of the representative media files of the at least one subset.

In one embodiment, in order to identify a representative portion of respective media files downloaded, the electronic device may be further configured to receive, from the network entity, a start time and at least one of an end time or length of the representative portion of respective media files downloaded to the electronic device. In another embodiment, in order to identify one or more representative media files of respective subsets, the electronic device may be further configured to receive, from the network entity, an indication of a frequency with which respective media files of the subset have been downloaded by one or more other electronic devices.

According to yet another aspect, a method is provided for generating a preview of a subset or collection of media files stored on an apparatus. In one exemplary embodiment, the method may include: (1) obtaining a plurality of media files; (2) identifying a representative portion of respective media files obtained; (3) defining one or more subsets of the plurality of media files; (4) identifying one or more representative media files of respective subsets, wherein the identified media files are representative of the corresponding subset; (5) receiving a request to preview at least one of the subsets of the plurality of media files; and (6) generating and output, in response to the request received, a combination of the representative portions of the representative media files of the at least one subset.

In accordance with yet another aspect, a computer program product is provided for generating a preview of a subset or collection of media files stored on an apparatus. The computer program product contains at least one computer-readable storage medium having computer-readable program code portions stored therein. The computer-readable program code portions of one exemplary embodiment include: (1) a first executable portion for obtaining a plurality of media files; (2) a second executable portion for identifying a representative portion of respective media files obtained; (3) a third executable portion for defining one or more subsets of the plurality of media files; (4) a fourth executable portion for identifying one or more representative media files of respective subsets, wherein the identified media files are representative of the corresponding subset; (5) a fifth executable portion for receiving a request to preview at least one of the subsets of the plurality of media files; and (6) a sixth executable portion for generating and outputting, in response to the request received, a combination of the representative portions of the representative media files of the at least one subset.

According to another aspect, an apparatus is provided for generating a preview of a subset or collection of media files stored on the apparatus. In one embodiment, the apparatus may include: (1) means for obtaining a plurality of media files; (2) means for identifying a representative portion of respective media files obtained; (3) means for defining one or more subsets of the plurality of media files; (4) means for identifying one or more representative media files of respective subsets, wherein the identified media files are representative of the corresponding subset; (5) means for receiving a request to preview at least one of the subsets of the plurality of media files; and (6) means for generating and outputting, in response to the request received, a combination of the representative portions of the representative media files of the at least one subset.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a block diagram of one type of system that would benefit from embodiments of the present invention;

FIG. 2 is a schematic block diagram of an entity capable of operating as a Media Provider Server in accordance with embodiments of the present invention;

FIG. 3 is a schematic block diagram of a mobile station capable of operating in accordance with an embodiment of the present invention; and

FIG. 4 is a flow chart illustrating the process of generating a preview of a media file or subset/collection of media files stored on a user's device in accordance with embodiments of the present invention.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, system, method and computer program product for generating and providing a user of an electronic device (e.g., cellular telephone, personal digital assistant (PDA), personal computer (PC), laptop, etc.) with a preview of one or more media files and/or collections of media files stored on the user's device and/or on a media provider server, wherein the preview is specifically designed to provide a comprehensive and representative example of the media file and/or collection. In one embodiment, the preview may, therefore, enable the user to more quickly and easily recognize the media file and/or collection of media files.

In particular, according to one embodiment, media files (e.g., audio and/or video files) stored on the user's device may be placed in one or more subsets or collections. These subsets or collections may be defined, for example, based on a common parameter associated with respective media files. For example, all songs by the same artist may fall within one subset or collection; all songs appearing on a particular album may fall within another subset or collection; all movies categorized as within a certain genre may fall within yet another subset or collection; and the like. Within each subset or collection, one or more media files may be selected as being particularly representative of the subset or collection as a whole. In one embodiment, the purpose of this selection may be to select those media files that the user is most likely to quickly recognize. As a result, in one embodiment, the representative media files of a particular subset may be selected based on the frequency with which those media files were output by the user (e.g., the most frequently watched romance movies may be selected as the representative video files for the collection associated with the romance genre). In addition, the representative portion of each media file may be defined. As with the selection of representative media files of the subset, a portion of the media file may be selected as representative of the media file because it is the most likely portion of the media file to be recognized by the user or others familiar with the media file. This may include, for example, the chorus of a song, or the climax of a television program or movie.

Using this information (i.e., the representative media files of a subset or collection, and the representative portion of the media files), a preview of respective subsets or collections can be generated that is comprehensive and representative of the subset or collection and/or is most likely to enable the user to quickly recognize the subset or collection. For example, a user may request to hear a preview of an artist in order to remember what that artist sounds like. In response to the request, the user's device (e.g., a processor or similar means operating on the user's device) may combine the chorus of the selected artist's most popular songs (e.g., those most listened to by the user) and play the combination for the user.

In another embodiment, a similar process may be performed by a media provider server in response to receiving a request from a user to preview, for example, the songs of a particular artist or the films of a particular producer and/or director. For example, a user may be browsing a particular music store service (e.g., via either a Web browser or dedicated software accessing a network service) and decide that he or she would like to hear a preview of a particular band or artist. A server associated with the music store service (e.g., a processor or similar means operating on the server) may create a preview by, for example, selecting the most popular songs by the artist (e.g., one or more per album of the band or artist). As above, the popularity of the songs may be based on the frequency with which respective songs are downloaded or purchased and/or various ratings provided to the songs by other listeners. A representative portion of each song selected (e.g., the chorus) may then be located and combined together in order to create the preview.

### Overall System and Electronic Device:

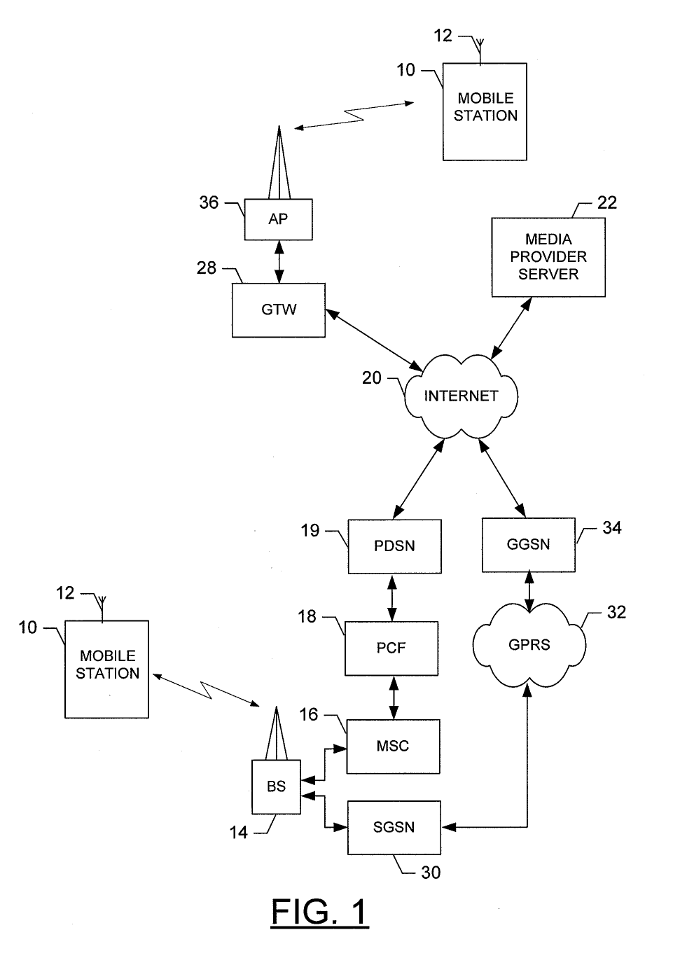

Referring to FIG. 1, an illustration of one type of system that would benefit from exemplary embodiments of the present invention is provided. As shown in FIG. 1, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include a Media Provider Server 22, discussed below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including Wireless LAN (WLAN) techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., Media Provider Server 22) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to one or more processing elements (e.g., a server associated with a Media Provider 22) across the Internet 20, one or more such entities may be directly coupled to one another. As such, one or more network entities may communicate with one another in accordance with, for example, RF, BT, IrDA or any of a number of different wireline or wireless communication techniques, including LAN and/or Wireless LAN techniques. Further, the mobile station 10 and the processing elements can be coupled to one or more electronic devices, such as printers, digital projectors and/or other multimedia capturing, producing and/or storing devices (e.g., other terminals).

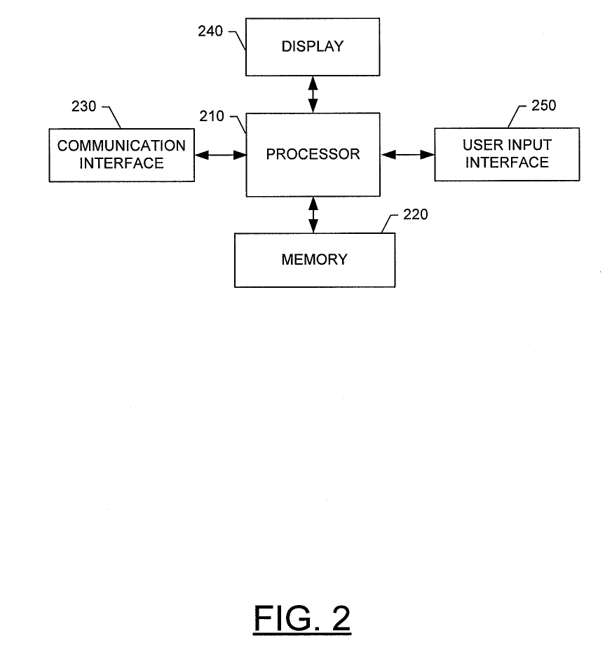

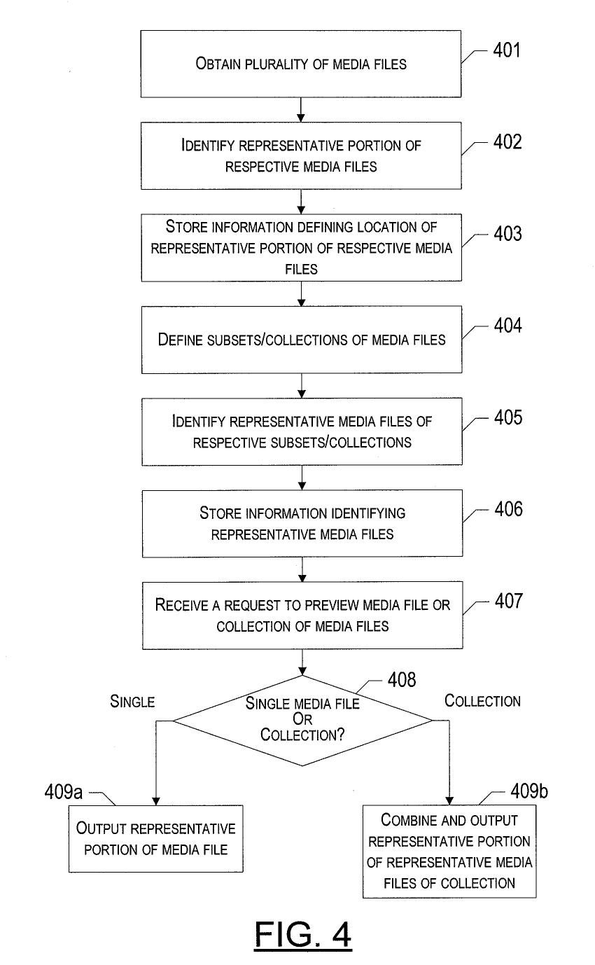

Referring now to FIG. 2, a block diagram of an entity capable of operating as a Media Provider Server 22 is shown in accordance with one embodiment of the present invention. The entity capable of operating as a Media Provider Server 22 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a Media Provider Server 22 can generally include means, such as a processor 210 for performing or controlling the various functions of the entity. For example, the processor 210, or similar means, may be configured to generate a preview of a collection or subset of media files associated with the Media Provider Server 22, for example, in the manner described herein with reference to FIG. 4. In one embodiment, the processor is in communication with or includes memory 220, such as volatile and/or non-volatile memory that stores content, data or the like. For example, the memory 220 typically stores content transmitted from, and/or received by, the entity. Also for example, the memory 220 typically stores software applications, instructions or the like for the processor to perform steps associated with operation of the entity in accordance with embodiments of the present invention.

In particular, according to one embodiment, the memory 220 may store a plurality of media files (e.g., songs, television programs, movies, etc.) capable of being downloaded to one or more electronic devices over a network. The memory 220 may further store, in relation to respective media files and, for example, as metadata associated with the corresponding media file, an indication of the start and end time/length of a representative portion of the corresponding media file (e.g., chorus or climax). The memory 220 may further store instructions for the processor to monitor the frequency with which respective media files stored in memory 220 are downloaded to various electronic devices and to provide this information, either automatically when the corresponding media file is downloaded or upon request. As discussed in more detail below, this information may be used by a user's electronic device or by the processor 210, or similar means associated with the Media Provider Server 22, to determine which media files of a subset/collection of media files are most representative of that subset or collection (i.e., those media files that are most likely to be quickly recognized by the user). The memory 220 may further store instructions for the processor 210 to create a preview of a collection or subset of stored media files, for example, in the manner described herein with reference to FIG. 4.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

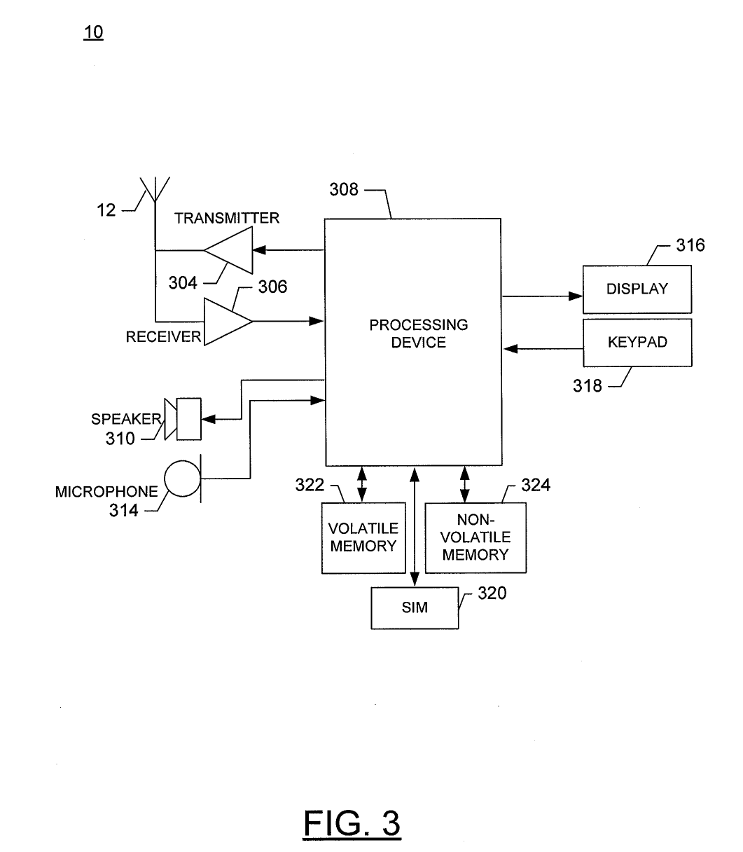

Reference is now made to FIG. 3, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that the mobile station may include alternative means for performing one or more like functions, without departing from the spirit and scope of the present invention. More particularly, for example, as shown in FIG. 3, in addition to an antenna 302, the mobile station 10 includes a transmitter 304, a receiver 306, and an apparatus that includes means, such as a processing device 308, e.g., a processor, controller or the like, that provides signals to and receives signals from the transmitter 304 and receiver 306, respectively, and that performs the various other functions described below including, for example, the functions relating to providing a user with a preview of one or more media files or subsets/collections of media files stored in memory on the mobile station 10.

As discussed in more detail below with regard to FIG. 4, in one embodiment, the processor 308 may be configured to obtain a plurality of media files (e.g., audio and/or video files), for example by downloading one or more of the media files from a web site associated with the Media Provider Server 22 discussed above and/or by receiving one or more of the media files directly from another electronic device (e.g., operated by a friend, family member or colleague). The processor 308 may further be configured to identify a representative portion of respective media files obtained (e.g., a chorus or climax), define one or more subsets or collections of the plurality of media files (e.g., based on a parameter associated with respective media files, or based on a user-defined play list), and identify one or more media files of respective subsets that are representative of the subset of media files as a whole (e.g., the most well-recognized media files of the subset). The processor 308 may thereafter be configured, upon receipt of a request from a user of the mobile station 10, to generate and output a preview of respective subsets or collections of media files, wherein the preview includes a combination of the representative portions of the representative media files of the subset or collection.

As one of ordinary skill in the art would recognize, the signals provided to and received from the transmitter 304 and receiver 306, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. For example, the memory may store a plurality of media files downloaded or received by the user and including one or more audio and/or video files, such as songs, television programs, movies or the like.

The memory may further store computer program code for an application and other computer programs. For example, in one embodiment of the present invention, the memory may store computer program code for identifying a representative portion of respective media files stored in memory, defining one or more subsets or collections of the plurality of media files, and identifying one or more media files of respective subsets that are representative of the subset of media files as a whole. The memory may further store computer program code for generating and outputting, in response to receiving a request from a user of the mobile station 10, a preview of respective subsets or collections of media files, wherein the preview includes a combination of the representative portions of the representative media files of the subset or collection.

The apparatus, system, method and computer program product of embodiments of the present invention are primarily described in conjunction with mobile communications applications. It should be understood, however, that the apparatus, system, method and computer program product of embodiments of the present invention can be utilized in conjunction with a variety of other applications, both in the mobile communications industries and outside of the mobile communications industries. For example, the apparatus, system, method and computer program product of embodiments of the present invention can be utilized in conjunction with wireline and/or wireless network (e.g., Internet) applications.

### Method of Providing a Preview of Media Files and Collections of Media Files

Referring now to FIG. 4, the operations are illustrated that may be taken in accordance with one embodiment of the present invention in order to create a preview of a media file, or a collection of media files, stored in memory on a user's device (e.g., cellular telephone, personal digital assistant (PDA), personal computer (PC), laptop, or the like). As one of ordinary skill in the art will recognize, embodiments of the present invention may similarly apply to media files stored in association with a media provider server, wherein the Media Provider Server and, in particular, a processor or similar means operating on the Media Provider Server performs the functions described below. The following description with regard to media files stored on a user's device are, therefore, provided for exemplary purposes only and should not be taken in any way as limiting the scope of embodiments of the present invention.

As shown in FIG. 4, the process may begin at Block 401, when a user obtains a plurality of media files for storing on his or her device. These media files may include, for example, one or more audio and/or video files, such as songs, movies, television programs, or the like. In one embodiment, the user may obtain one or more of the media files by downloading the media files from a web site associated with a particular media provider. Alternatively, or in addition, one or more of the media files may be streamed to the user's electronic device directly from devices operated by his or her friends, family members, colleagues, or the like.

Once the media files have been obtained, the user's device, and in particular a processor or similar means operating on the user's device, may identify a representative portion of respective media files obtained (Block 402), and then store information defining the location of the representative portion, or the representative portion itself, in association with the corresponding media file (e.g., as metadata associated with the media file or as a separate media file that is, for example, mapped to the original media file) (Block 403). In one embodiment, the representative portion of a media file may be that portion which is the most representative of the media file and/or is the most likely to be recognized or remembered by a user listening to and/or viewing the media file. Accordingly, the representative portion may include, for example, the chorus or refrain of a song or audio file, wherein, as one of ordinary skill in the art will recognize, the chorus or refrain refers generally to the recurring portion or phrase of the song or audio file. Similarly, the representative portion may include, for example, the climax of a television program, movie or similar video file, wherein the television program, movie or similar video file may include more than one climax and, therefore, more than one representative portion. Based on the foregoing, the information defining the location of the representative portion may include the start time of the chorus and/or at least one climax, with respect to the underlying media file, as well as either the end time or the length of the chorus and/or at least one climax.

In one embodiment, identifying a representative portion may involve receiving, from the media provider server, from which the user downloaded the media file, information defining the location of the representative portion of the media file, or the representative portion itself. The server may provide this information when the media file is first downloaded to the user's device, or at some later point in time. In addition, the server may do so automatically and/or in response to a request from the user. Alternatively, in another embodiment, the user's device, and in particular the processor or similar means operating on the user's device, may execute software that uses algorithms that are known to those of ordinary skill in the art for the purpose of identifying the chorus of an audio file. (See e.g., Masataka Goto: A Chorus-Section Detecting Method for Musical Audio Signals, ICASSP 2003 (The 2003 IEEE International Conference on Acoustics, Speech, and Signal Processing) Proceedings, pp. V-437,440, April 2003, the contents of which are hereby incorporated herein by reference). As with downloading the information from the media provider server, this chorus-locating software may be executed automatically, and/or upon request by the user, each time the user downloads or receives a new audio file, and/or periodically following download of the media file.

At some point, one or more subsets or collections of the media files stored on the user's device may be defined. (Block 404). In particular, according to one embodiment, the processor or similar means operating on the user's device may define one or more parameters associated with respective media files. For audio files (e.g., songs), these parameters may include, for example, the name of the artist or artists performing the song (e.g., singer and/or band name), the title of the album on which the song appears, the genre within which the song may be categorized (e.g., alternative, folk, rap, R&B, jazz, classical, etc.), the year in which the song was produced, and/or the country from which the song generated. Similarly, for video files (e.g., television programs or movies), these parameters may include, for example, the name of the actor or actors performing in the program or movie, the name of the producer and/or director of the program or movie, the title of the television series of which the television program is a part, the genre within which the program or movie would be categorized (e.g., romance, comedy, drama, thriller, horror, etc.), the year in which the program was produced, and/or the country from which the program or movie generated. As one of ordinary skill in the art will recognize, the foregoing parameters are provided for exemplary purposes only and should not be taken in any way as limiting the scope of embodiments of the present invention. Other, similar parameters may likewise be used without departing from the spirit and scope of embodiments of the present invention. In one embodiment, the information necessary for defining at least some of these parameters may be obtained from the metadata associated with the corresponding media file.

The processor, or similar means, may thereafter form subsets of the media files based on common parameters (e.g., media files having substantially similar definitions for a given parameter). For example, all songs appearing on the same album may form one subset or collection; all songs performed by the same singer or band may form another subset or collection; and all movies directed by the same director may form yet another subset or collection; and the like. In addition, in another embodiment, one or more subsets may be defined based on input by the user. In particular, the user may create his or her own collection or subset of media files, referred to as a “play list.”

As one of ordinary skill in the art will recognize, the subsets created, either based on common parameters or input by the user, may not be mutually exclusive. In other words, certain media files may belong to more than one subset, causing the subsets to overlap. For example, Starálfur, a song by the band Sigur Rós, may appear both in the subset associated with Sigur Rós and including all other songs owned by the user that are by Sigur Rós, as well as in the subset associated with the album on which Starálfur appears, Ágaetis Byrjun (A Good Beginning). Similarly, the song Starálfur may appear in a subset associated with the year 1999 and/or the country Iceland, as well as in a subset based on a user's defined play list.

Once the subsets or collections of media files have been defined, one or more representative media files from each subset or collection may be further defined (Block 405), and information identifying the representative media files may be saved, for example, as metadata associated with those media files (Block 406). In other words, the processor, or similar means, operating on the user's device may identify those media files within each subset that that user is most likely to recognize and/or are most representative of the subset or collection. In one embodiment, in order to identify the representative media files of each subset, the processor, or similar means, may monitor the user's listening and/or viewing history. In particular, the processor, or similar means, may keep track of the number of times each media file is output by the user. The processor, or similar means, can thereafter determine which media files the user is most likely to recognize (i.e., the representative media files) based on the media files of the subset that were most frequently output by the user. Alternatively, or in addition, the user's device (e.g., the processor or similar means operating on the user's device) may receive, for example from the media provider server from which one or more of the media files were downloaded, statistical information regarding the popularity of respective media files. In particular, the media provider server may provide information regarding the number of times respective media files were purchased, or otherwise downloaded, from the web site associated with the media provider server, by other electronic device users. The processor, or similar means, operating on the user's device may use this information to determine which media files are more popular and, therefore, more likely to be recognized by the user. In yet another embodiment, in order to identify representative media files, the processor or similar means operating on the user's device may receive an indication of an expert's selection of representative media files.

In yet another embodiment, the processor, or similar means, operating on the user's device, may receive input directly from the user that indicates the user's preferences regarding the media files he or she owns. In particular, the user may be given some means for rating or ranking respective media files stored on his or her device. This rating or ranking may thereafter be stored in association with the corresponding media file, for example as metadata, and used by the processor, or similar means, to determine which media files the user prefers and which, therefore, are more likely to be recognized. These media files may then make up the one or more representative media files for their corresponding subset or collection.

The user may thereafter be browsing his or her media collection and indicate, such as actuating an icon or selecting an item from a menu, to the processor, or similar means, operating on his or her device, that he or she would like to hear and/or see a preview of one of the media files stored on his or her device, or a subset or collection of those media files. (Block 407). In particular, the user's electronic device display screen may be configured to display various indicia associated with the media files stored on the user's device. For example, the display screen may be configured to display the titles (e.g., song, television program and/or movie titles) of each media file stored on the user's device in alphabetical order and in categories based on their media type (e.g., all song titles listed in alphabetical order separately from movie titles that are likewise listed in alphabetical order).

The display may further be configured to display indicia associated with the subsets or collections of media files defined at Block 404. For example, the display screen may provide a list of genres, years, countries, recording artists, producers, directors, television series, and the like, corresponding to the defined subsets or collections of media files stored on the user's device. Where, for example, the subset or collection is based on a play list defined by the user, the user may be required to provide a name or title for the play list (e.g., “My Favorite Country Songs) that can be displayed on the user device display screen.

In one embodiment, the user's device, and in particular a processor or similar means operating on the user's device, may receive a request from the user to preview a media file or a subset of the media files, in response to the user simply placing his or her cursor over the indicia associated with the media file or subset of media files. In other words, the user may be able to indicate his or her desire to preview a media file or subset of media files by simply placing his or her cursor over, for example, the title of the song, television program or movie he or she would like to preview, or the album name, recording artist, genre, year, country, or the like, associated with the subset or collection of media files he or she would like to preview. In one embodiment, in order to prevent accidental preview playing, the user may be required to hold his or her mouse over the indicia (e.g., title, artist name, etc.) for some predefined period of time (e.g., two seconds) before the preview is stored.

If, as it is determined at Block 408, the user has requested to preview a media file stored on the user's device, the processor, or similar means, operating on the user's device may, at Block 409a, output the representative portion of the media file for which the preview was requested. In particular, in one embodiment, the processor, or similar means, may use the metadata associated with the media file to determine the location of the representative portion (e.g., the start time and either the end time or the length), and then output that portion. As noted above, where, for example, the media file is an audio file or song, this may involve playing the chorus of the song for the user, since this is the mostly likely portion of the song that the user will recognize.

If, on the other hand, it is determined at Block 408 that the user has requested to preview a subset or collection of media files stored on the user's device, the processor, or similar means, may, at Block 409b, output a combination of the representative portion of each representative media file of the subset or collection. In particular, in one embodiment, the processor, or similar means, may first determine which of the media files of the subset or collection, for which a preview was requested, were defined as the representative media files. The processor may do so, for example, by reviewing the metadata associated with respective media files of the subset or collection. Once the representative media files have been determined, the processor, or similar means, may determine where the representative portions of those representative media files are located, again based, for example, on the metadata associated with those media files. The processor, or similar means, can then combine the representative portions of the representative media files and output the combination to the user. This may include, for example, the chorus of the three or four most popular songs on an album, or by a particular singer or band. Similarly, this could include the climax of the best episodes of a particular television series, or of the most popular movies starring a particular actor. In one embodiment, special techniques known to those of ordinary skill in the art may be used in order to ensure that the representative portions of the representative media files blend. These may include, for example, fading and/or tempo changing techniques that try to match or blend the end and beginning of neighboring audio files.

In addition to the foregoing, in one embodiment, if the user continues to play a preview for a particular subset of media files (e.g., a preview of a selected album) after the representative portion of the representative media files have finished (e.g., the chorus of each of the three or four most popular songs have played), the representative portion of additional media files within the subset mat be added to the preview until the user indicates his or her desire to stop the preview play (e.g., by moving the mouse off of the album title). Alternatively, the preview may stop on its own once the representative portion of each representative media file has been played, regardless of what the user does.

While the foregoing description assumes that the information identifying the representative media files and the representative portions thereof is determined and stored at some point prior to receiving a request from the user to preview the corresponding media file subset or collection, as one of ordinary skill in the art will recognize, these operations may alternatively be performed dynamically, or on the fly, each time such a request is received. By dynamically identifying the representative media files and portions thereof, the need to store the information identifying those media files and portions (i.e., the processes of Blocks 403 and 406 above) may be obviated.

In addition, according to one embodiment of the present invention, a user's device, and in particular a processor or similar means operating on the user's device, may enable the user to preview one media file or subset of media files while he or she is listening to and/or viewing another media file or preview of a media file or subset of media files. For example, assume that a song is currently being played by the user's device, and the user would like to preview other songs in order to determine which song to play next. According to one embodiment of the present invention, the song, or similar media file, currently being played may be shifted to one of two stereo output channels of the device (e.g., the right channel). At the same time, the preview may be played on the other stereo output channel (e.g., the left channel). In one embodiment, the volume of the preview may be lowered with respect to that of the currently playing media file in order to limit the amount of disruption.

As discussed above, embodiments of the present invention enable a user to quickly and easily preview the media files (e.g., songs, movies, television programs, etc.), as well as the collections or subsets of media files (e.g., albums, television series, songs with the same singer or band, etc.) stored on his or her device. More specifically, embodiments of the present invention reduce the amount of time necessary for a user to recognize a media file or collection of media files by providing the user with a preview of not only the most representative or recognizable portion of the media files themselves, but also the most representative or recognizable media files of the subset or collection.

### Conclusion:

As described above and as will be appreciated by one skilled in the art, embodiments of the present invention may be configured as an apparatus, system and method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processing device 308 discussed above with reference to FIG. 3, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processing device 308 of FIG. 3) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processor configured to:
obtain a plurality of media files;
identify a representative portion of respective media files obtained;
define one or more subsets of the plurality of media files;
identify one or more representative media files of respective subsets, wherein the identified media files are representative of the corresponding subset;
receive a request to preview at least one of the subsets of the plurality of media files; and
generate and output, in response to the request received, a combination of the representative portions of the representative media files of the at least one subset.

2. The apparatus of claim 1, wherein the plurality of media files comprises one or more audio files, one or more video files, or a combination thereof.

3. The apparatus of claim 2, wherein in order to identify a representative portion of respective media files, the processor is further configured to:
identify a start time and at least one of an end time or length of a chorus associated with respective audio files.

4. The apparatus of claim 2, wherein in order to identify a representative portion of respective media files, the processor is further configured to:
identify a start time and at least one of an end time or length of at least one climax associated with respective video files.

5. The apparatus of claim 1, wherein in order to identify a representative portion of respective media files, the processor is further configured to:
receive at least one of an indication of a location associated with the representative portion or the representative portion itself.

6. The apparatus of claim 1, wherein the processor is further configured to:
extract the representative portion from respective media files; and
store respective extracted representative portions in association with the corresponding media file.

7. The apparatus of claim 2, wherein in order to define one or more subsets of the plurality of media files, the processor is further configured to:
define at least one parameter associated with respective media files, wherein respective subsets comprise one or more media files having a substantially similar definition associated with the parameter.

8. The apparatus of claim 7, wherein the parameter is selected from a group consisting of an album title, a recording artist, a genre, a year, a country, a television series title, an actor, a producer and a director.

9. The apparatus of claim 1, wherein in order to define one or more subsets of the plurality of media files, the processor is further configured to:
receive, as an input from a user of the apparatus, a play list including one or more media files of the plurality of media files.

10. The apparatus of claim 1, wherein in order to identify one or more representative media files of respective subsets, the processor is further configured to:
monitor a number of times a user of the apparatus outputs respective media files to determine which of the one or more media files of the subset are more frequently output.

11. The apparatus of claim 1, wherein in order to identify one or more representative media files of respective subsets, the processor is further configured to:
receive an indication of at least one of a frequency with which respective media files of the subset have been downloaded by one or more electronic devices or an expert selection of one or more media files.

12. A system comprising:
a network entity; and
an electronic device in communication with the network entity over a network for the purpose of downloading a plurality of media items, said electronic device configured to:
identify a representative portion of respective media files downloaded;
define one or more subsets of the plurality of media files;
identify one or more representative media files of respective subsets, wherein the identified media files are representative of the corresponding subset;
receive a request to preview at least one of the subsets of the plurality of media files; and
generate and output, in response to the request received, a combination of the representative portions of the representative media files of the at least one subset.

13. The system of claim 12, wherein in order to identify a representative portion of respective media files downloaded, the electronic device is further configured to receive, from the network entity, a start time and at least one of an end time or length of the representative portion of respective media files downloaded to the electronic device.

14. The system of claim 12, wherein in order to identify one or more representative media files of respective subsets, the electronic device is further configured to receive, from the network entity, an indication of at least one of a frequency with which respective media files of the subset have been downloaded by one or more other electronic devices or an expert selection of one or more media files.

15. A method comprising:
obtaining a plurality of media files;
identifying a representative portion of respective media files obtained;
defining one or more subsets of the plurality of media files;
identifying one or more representative media files of respective subsets, wherein the identified media files are representative of the corresponding subset;
receiving a request to preview at least one of the subsets of the plurality of media files; and
generating and output, in response to the request received, a combination of the representative portions of the representative media files of the at least one subset.

16. The method of claim 15, wherein the plurality of media files comprises one or more audio files, one or more video files, or a combination thereof.

17. The method of claim 16, wherein identifying a representative portion of respective media files further comprises:
identifying a start time and at least one of an end time or length of a chorus associated with respective audio files.

18. The method of claim 16, wherein identifying a representative portion of respective media files further comprises:
identifying a start time and at least one of an end time or length of at least one climax associated with respective video files.

19. The method of claim 15, wherein identifying one or more representative media files of respective subsets further comprises:
monitoring a number of times a user of the apparatus outputs respective media files to determine which of the one or more media files of the subset are more frequently output.

20. A computer program product comprising at least one computer-readable storage medium having computer-readable program code portions stored therein, wherein the computer-readable program code portions comprise:
a first executable portion for obtaining a plurality of media files;
a second executable portion for identifying a representative portion of respective media files obtained;
a third executable portion for defining one or more subsets of the plurality of media files;
a fourth executable portion for identifying one or more representative media files of respective subsets, wherein the identified media files are representative of the corresponding subset;
a fifth executable portion for receiving a request to preview at least one of the subsets of the plurality of media files; and
a sixth executable portion for generating and output, in response to the request received, a combination of the representative portions of the representative media files of the at least one subset.

21. The computer program product of claim 20, wherein the plurality of media files comprises one or more audio files, one or more video files, or a combination thereof.

22. The computer program product of claim 21, wherein the second executable portion is configured to:
identify a start time and at least one of an end time or length of a chorus associated with respective audio files; and
identify a start time and at least one of an end time or length of at least one climax associated with respective video files.

23. An apparatus comprising:
means for obtaining a plurality of media files;
means for identifying a representative portion of respective media files obtained;
means for defining one or more subsets of the plurality of media files;
means for identifying one or more representative media files of respective subsets, wherein the identified media files are representative of the corresponding subset;
means for receiving a request to preview at least one of the subsets of the plurality of media files; and
means for generating and outputting, in response to the request received, a combination of the representative portions of the representative media files of the at least one subset.

24. The apparatus of claim 23, wherein the plurality of media files comprises one or more audio files, one or more video files, or a combination thereof, and wherein the means for identifying a representative portion of respective media files further comprises means for identifying a start time and at least one of an end time or length of a chorus or climax associated with respective media files.

25. The apparatus of claim 23, wherein the means for defining one or more subsets of the plurality of media files further comprises:
means for defining at least one parameter associated with respective media files, wherein respective subsets comprise one or more media files having a substantially similar definition associated with the parameter, and wherein the parameter is selected from a group consisting of an album title, a recording artist, a genre, a year, a country, a television series title, an actor, a producer and a director.
